(19) United States
(12) Patent Application Publication
(10) Pub. No.: US 2011/0120128 A1
(43) Pub. Date: May 26, 2011

(54) METHOD OF CONTROLLING A POWER PLANT

(75) Inventors: Nareshkumar B. Handagama, Knoxville, TN (US); Stephen Hepner, Althausern (CH); Raesh R. Kotdawala, Knoxville, TN (US); Jacques Marchand, Sermanagny (FR); Allen M. Pfeffer, Windsor Locks, CT (US); Vikram S. Shabde, Knoxville, TN (US)

(73) Assignee: ALSTOM Technology Ltd, Baden (CH)

(21) Appl. No.: 12/622,748

(22) Filed: Nov. 20, 2009

(51) Int. Cl. F01K 13/02; F01K 25/06; F23J 15/02

(52) U.S. Cl. 60/649; 60/660; 110/203

(57) ABSTRACT

The present invention relates to a method of controlling a power plant, which power plant comprises: a boiler being adapted for combusting an organic fuel and for generating steam and a process gas comprising carbon dioxide; a steam system being; and a carbon dioxide capture system being adapted to remove at least a portion of the carbon dioxide from the process gas by contacting a carbon dioxide absorbent solution with the process gas, the method comprising: forwarding a portion of the steam produced by the power plant boiler to a regenerator of the carbon dioxide capture system; regenerating the absorbent solution in said regenerator through heating of said carbon dioxide absorbent solution by means of the forwarded steam; and automatically controlling the operation of the carbon capture system by means of at least one automatic controller. The invention also relates to a power plant including a carbon dioxide capture system.

### TECHNICAL FIELD

The present invention relates to a method of controlling a power plant including a carbon dioxide capture system.

### BACKGROUND

Most of the energy used in the world today is derived from the combustion of carbon and hydrogen containing fuels such as coal, oil and natural gas, as well as other organic fuels. Such combustion generates flue gases containing high levels of carbon dioxide. Due to concerns about global warming, there is an increasing demand for the reduction of emissions of carbon dioxide to the atmosphere, why methods have been developed to remove the carbon dioxide from flue gases before the gas is released to the atmosphere.

Systems for removal of carbon dioxide from a flue gas have been proposed and includes contacting the flue gas with an aminated or ammoniated absorbent solution to allow capture of carbon dioxide from the flue gas by the absorbent solution.

### SUMMARY

An objective of the present invention is to improve the control of a power plant including a carbon dioxide capture system.

This objective, as well as other objectives that will be clear from the following discussion, is according to one aspect achieved by a method of controlling a power plant, which power plant comprises: a power plant boiler being adapted for combusting an organic fuel and for generating steam and a process gas comprising carbon dioxide; a steam system being adapted for utilizing at least a portion of the energy content of at least a portion of the steam generated by said power plant boiler; and a carbon dioxide capture system being adapted to remove at least a portion of the carbon dioxide from at least a portion of said process gas by contacting a carbon dioxide absorbent solution with the process gas such that carbon dioxide from said process gas generated in the power plant boiler is captured by the carbon dioxide absorbent making the carbon dioxide absorbent rich in carbon dioxide, the method comprising: forwarding a regenerator portion of the steam produced by the power plant boiler to a regenerator of the carbon dioxide capture system; at least partly regenerating the absorbent solution in said regenerator through heating of said carbon dioxide absorbent solution when it is rich in carbon dioxide, by means of the forwarded steam to make the absorbent solution carbon dioxide lean; and automatically controlling the operation of the carbon capture system by means of at least one automatic controller.

The carbon dioxide capture system is thus integrated into the power plant, both by the carbon dioxide capture system removing carbon dioxide from the process gas from the boiler and by steam from said boiler being forwarded to the regenerator of the carbon dioxide capture system. By integrating the carbon dioxide capture system in the power plant, the operation of the carbon dioxide capture system may be better and more easily adapted to the operation and requirements of the rest of the power plant. Also, the power output of the whole power plant, including the carbon dioxide capture system, may be more easily observed and controlled.

By using steam from the power plant boiler for regeneration of the absorbent solution, there is no need for a separate heat source for heating the absorbent solution, simplifying the power plant design. It is also noted that the power needed to regenerate the absorbent solution with e.g. an electrical heater may be more than the loss in power production from forwarding a portion of the boiler produced steam to the regenerator.

By regenerating the absorbent solution, i.e. removing carbon dioxide from the solution thereby making the solution unsaturated or lean with regard to carbon dioxide, the absorbent solution may be reused in the carbon dioxide capture system for removing carbon dioxide from the process gas.

By automatically controlling at least a part of the operation of the carbon dioxide capture system by means of at least one automatic controller, such as a PID controller operating towards a fixed setpoint, the control of the operation may be facilitated, reducing the need to manually control the operation of the system.

The regenerator steam portion may be forwarded from the power plant boiler to the regenerator of the carbon dioxide capture system via the steam system. This implies that the portion of steam may be used also by the steam system, in addition to the regenerator, reducing the total production need of steam for the power plant.

The operation of the carbon dioxide capture system may be controlled automatically by a plurality of automatic controllers, i.e. not just by one automatic controller. This may facilitate increased automatic control of the system, and may also increase the system's adaptability to the rest of the power plant. The control may be more precise and finely tuned with a plurality of automated controllers. The plurality of controllers may also be controlled by an automatic master controller. This implies that the plurality of controllers may be jointly controlled on a higher level, allowing the controllers to be operated together and in relation to each other.

The at least one controller may be part of an optimization system arranged to optimize the overall operation of the power plant. This implies that the carbon dioxide capture system may be operated in relation to the rest of the power plant in order to enhance the operation of the power plant as a whole.

The optimization may e.g. be performed by continuously calculating and assigning setpoints to the at least one controller. By recalculating and reassigning setpoints to the controller, the operation of the carbon dioxide capture system may be automatically controlled and adapted to the operation of the whole power plant also when operational parameters or other conditions relevant to the operation of the power plant changes over time.

The operation of the power plant may be optimized e.g. by using steady state optimization or by using dynamic optimization.

The operation of the power plant may be optimized offline or online.

The operation of the power plant may be optimized by optimization of the carbon dioxide capture system and/or other parts of the power plant, such as the steam system and/or the boiler, separately, sequentially or jointly.

The operation of the power plant may be optimized based on the minimization of an objective function of at least one variable selected from the group consisting of manipulated variables, controlled variables and disturbance variables, related to the operation of the power plant, and/or the operation of the power plant may be optimized based on differential game and/or on Pontryagin's Minimum Principle.

The operation of the power plant including the carbon dioxide capture system may be optimized with regard to maximum power output of the power plant, while maintaining carbon dioxide capture at a prescribed level. The level might be a prescribed total amount of captured carbon dioxide per time unit or per process gas volume unit, or a captured percentage of the carbon dioxide of the process gas entering the carbon dioxide capture system, or a carbon dioxide concentration of the process gas leaving the carbon dioxide capture system. The power output may thus be maximized while still making sure that e.g. government prescribed maximum carbon dioxide emissions are not exceeded.

The operation of the power plant including the carbon dioxide capture system may be optimized such that the optimization includes a tradeoff between the power output of the power plant and the carbon dioxide capture level. This implies that the overall profitability of the plant can be optimized based e.g. on the revenue from selling produced energy and captured carbon dioxide contra the cost, in e.g. government fees, of carbon dioxide emissions to the atmosphere.

The at least one controller may control the regenerator portion amount of the steam forwarded to the regenerator.

The at least one controller may control the regenerator portion amount of the steam forwarded to the regenerator at least partially based on a measured value of at least one variable related to properties of a stream of the absorbent solution entering the regenerator, said measured value related to properties of a stream of the absorbent solution entering the regenerator being automatically received by the controller. The controller may thus control the amount of steam forwarded to the regenerator based on a value obtained from another part of the power plant, which value is relevant for the amount of steam needed to regenerate the absorbent solution. This may be a feedforward controller.

Alternatively, or additionally, the at least one controller may control the regenerator portion amount of the steam forwarded to the regenerator at least partially based on a measured value of at least one variable related to properties of a stream of the process gas from the power plant boiler, said measured value related to properties of a stream of the process gas from the power plant boiler being automatically received by the controller. This may be a feedforward controller.

Alternatively, or additionally, the at least one controller may control the regenerator portion amount of the steam forwarded to the regenerator at least partially based on a measured value of at least one variable related to properties of a stream of a carbon dioxide rich gas inside or leaving the regenerator, said measured value of at least one variable related to properties of a stream of a carbon dioxide rich gas inside or leaving the regenerator being automatically received by the controller. This may be a feedback controller.

A plurality of automatic controllers may be used to control the regenerator portion amount of the steam forwarded to the regenerator. These controllers may be one or several of the ones discussed above, or any other controller effective in controlling the regenerator portion amount of the steam forwarded to the regenerator. The controllers may cooperate to control the forwarded steam amount. The amount of forwarded steam may thus be dependent on a plurality of different measurements at a plurality of different places in the power plant, whereby the steam amount may be more precisely adapted to the operation of the power plant.

At least a portion of the regenerator portion of the steam forwarded to the regenerator may be returned to the power plant boiler as feedwater. Thus, the steam, or the condensate of the steam, may be reused in the boiler for producing new steam, increasing the self-sufficiency of the power plant and reducing the amount of waste water. This also contributes to the overall integration of the carbon dioxide capture system in the power plant.

The carbon dioxide capture system may comprise an absorber arrangement in which the process gas is contacted with an absorbent solution amount provided to the absorber arrangement, whereby carbon dioxide is captured from the process gas by the absorbent solution in the absorber arrangement. The absorber arrangement may be arranged to facilitate the contact between the process gas and the absorbent solution. The absorbent arrangement may comprise one or a plurality of absorbers. The at least one controller may control the absorbent solution amount provided to the absorber arrangement at least partially based on a measured value of at least one variable related to properties of a stream of the process gas, which stream is leaving the absorber arrangement, said measured value of at least one variable related to properties of a stream of the process gas being automatically received by the controller. The stream of process gas leaving the absorber arrangement may have a lower carbon dioxide content than the process gas entering the absorber arrangement since carbon dioxide may have been captured from the process gas by the absorbent solution.

The at least one variable discussed above in respect of many different contemplated automatic controllers may e.g. be one or several of flow rate, temperature, pressure and carbon dioxide concentration of the respective measured streams of steam, process gas and/or absorbent solution.

The at least one controller may control a feedwater heating portion amount of steam, forwarded from the power plant boiler, provided for heating of boiler feedwater fed to the boiler, the control being based on the regenerator portion amount of steam forwarded to the regenerator. Based on the amount of steam forwarded to the regenerator, the amount of steam used to heat the boiler feedwater may thus be controlled. It may e.g. be convenient to have a fixed ratio between steam to the regenerator and steam for the heating of boiler feedwater. Thus, if the amount of steam forwarded to the regenerator is increased, the amount of steam provided for heating boiler feedwater may also be increased.

The at least one controller may control the backpressure at an Intermediate pressure/low pressure crossover between an intermediate pressure steam turbine and a low pressure steam turbine by changing the flow rate, and thus the pressure, of steam from the intermediate pressure turbine to the low pressure turbine based on an amount of steam forwarded from the power plant boiler for heating of boiler feedwater fed to said boiler.

It may be convenient to allow at least a portion of the regenerator portion amount of steam to be siphoned off from a steam stream after said steam stream has passed through at least one steam turbine of the steam system. The steam generated by the boiler may thus first be used to produce power by means of one or a plurality of turbines in the power plant steam system, before it is siphoned off to the regenerator. The same may be applied for any steam portion provided for heating of the boiler feedwater.

The regenerator portion of steam forwarded to the regenerator may be any steam, of any pressure and temperature, directly or indirectly from the boiler. The steam forwarded to the regenerator may e.g. be intermediate pressure steam or low pressure steam, or a mixture of intermediate and low pressure steam. This implies that the steam may already have been used for power production in one or a plurality of turbines before being forwarded to the regenerator, thus not being high pressure steam. However, high pressure steam may also be used, by itself or in combination with intermediate and/or low pressure steam.

At least a portion of the steam produced by the power plant boiler may be condensed in a power plant condenser producing a condensate, wherein at least a portion of the condensate may be forwarded to a heat exchanger for cooling a carbon dioxide rich gas stream from the regenerator of the carbon dioxide capture system, after which the condensate portion may be returned to the boiler as feedwater. By utilizing the condensate portion to cool the carbon dioxide rich gas stream resulting from the regeneration of the absorbent solution, i.e. the carbon dioxide leaving the absorbent solution, the integration and energy efficiency of the power plant including the carbon dioxide capture system is additionally increased. The condensate portion amount forwarded to the heat exchanger may be automatically controlled by the at least one automatic controller.

According to another aspect, the present objective is achieved by a power plant comprising: a power plant boiler being adapted for combusting an organic fuel and for generating steam and a process gas comprising carbon dioxide; a steam system being adapted for utilizing at least a portion of the energy content of at least a portion of the steam generated by said power plant boiler; and a carbon dioxide capture system being adapted to remove at least a portion of the carbon dioxide from said process gas by contacting a carbon dioxide absorbent solution with the process gas such that carbon dioxide from said process gas generated in the power plant boiler is captured by the carbon dioxide absorbent making the carbon dioxide absorbent rich in carbon dioxide, the carbon dioxide capture system comprising: an absorption arrangement arranged to facilitate contact between the process gas and an absorbent solution, wherein the absorption arrangement is connected to the power plant such that at least a portion of the process gas produced by the boiler may be forwarded from the power plant to the absorption arrangement; a regenerator arranged to regenerate the absorbent solution such that absorbent solution, rich in captured carbon dioxide, is at least partly regenerated by removing carbon dioxide from the absorbent solution, wherein the regenerator is connected to the power plant such that at least a regenerator portion of the steam produced by the boiler may be forwarded from the power plant to the regenerator; and an automatic controller arranged to control the operation of the carbon dioxide capture system.

It may be convenient to use the power plant of this other aspect to perform the method discussed above.

The discussion above relating to the method is in applicable parts also relevant to the power plant. Reference is made to that discussion.

### BRIEF DESCRIPTION OF THE DRAWINGS

Currently preferred embodiments will now be discussed with reference to the drawings, in which:

FIG. 1 is a schematic process flow chart illustrating the steps of a method in accordance with an embodiment of the present invention.

FIG. 2 is a schematic front view of a power plant according to an embodiment in accordance with an embodiment of the present invention.

FIG. 3 is a schematic representation of the different levels of an optimization system in accordance with an embodiment of the present invention.

### DETAILED DESCRIPTION OF PREFERRED EMBODIMENTS

When the absorbent solution is referred to as “lean”, e.g. when contacting the process gas in the carbon dioxide capture system, or after regeneration, this implies that the absorbent solution is unsaturated with regard to carbon dioxide and may thus capture more carbon dioxide from the process gas. When the absorbent solution is referred to as “rich”, e.g. after contacting the process gas in the carbon dioxide capture system, or prior to regeneration, this implies that the absorbent solution is saturated, or at least almost saturated, or oversaturated with regard to carbon dioxide and may thus need to be regenerated before being able to capture any more carbon dioxide from the process gas or the carbon dioxide may be precipitated as a solid salt.

The absorbent solution may be any solution able to capture carbon dioxide from a process gas, such as an ammoniated solution or an aminated solution.

The capturing of CO₂ from the process gas by the absorbent solution may be achieved by the absorbent solution absorbing or dissolving the CO₂ in any form, such as in the form of dissolved molecular CO₂ or a dissolved salt.

The power plant comprises piping that connects the different parts of the system and is arranged to allow steam, absorbent solution, process gas etc., respectively, to flow within the power plant as needed. The piping may comprise valves, pumps, nozzles, heat exchangers etc. as appropriate to control the flows.

The steam system may comprise one or a plurality of steam turbines, linked to one or a plurality of generators for power production. It may be convenient to use at least three serially linked turbines designed to operate at different steam pressures. These turbines may be called high pressure turbine, intermediate pressure turbine and low pressure turbine, respectively. After passing through the low pressure turbine, the steam may be condensed in the condenser of the power plant. Steam from the boiler, prior to passing through the high pressure turbine may typically have a pressure of 150-350 bar. Steam between the high pressure turbine and the intermediate pressure turbine is called high pressure steam and may typically have a pressure of 62-250 bar. Steam between the intermediate pressure turbine and the low pressure turbine is called intermediate pressure steam and may typically have a pressure of 5-62 bar, such as 5-10 bar, and a temperature of between 154° C. and 277° C. (310° F. and 530° F.). Steam after passing the low pressure turbine is called low pressure steam and may typically have a pressure of 0.01-5 bar, such as 3-4 bar, and a temperature of between 135° C. and 143° C. (275° F. and 290° F.).

As discussed above, the proposed power plant is highly heat-integrated with regard to the interactions of the carbon dioxide capture system with other parts of the power plant. This may lower the energy consumption of the carbon dioxide capture system, and thus increase the total power production of the power plant. This integration also implies that the carbon dioxide capture system may be controlled together with the rest of the power plant. Thus the effect of the operation of other parts of the power plant on the carbon dioxide capture system operation, and vice versa, may be considered in an overall control strategy. The control strategy may be based upon the application of process models to compute operational parameters, trajectories, or operation setpoints for the carbon dioxide capture system, the other parts of the power plant, such as the steam cycle, or both. These techniques may be based on steady state or dynamic models of the carbon dioxide capture system, the other parts of the power plant, or both. These models can be comprehensive full scope models or partial models, e.g. models that only reflect the dominant interactions between the carbon dioxide capture system, the other parts of the power plant.

A plant-wide control system (PCS) may be used. In this optimization system, mathematical models of the entire power plant or parts thereof are developed. Specifically, these models may replicate the characteristics, which are important to the safe and reliable operation of the overall plant. Furthermore, the modelling technique may be but is not limited to a first-principles based modelling methodology or a data-driven modelling methodology, including but not limited to, artificial neural networks, auto-regressive moving average such as finite impulse response models or even some condition based model or a hybrid modelling strategy.

The models include variables of different classes.

Manipulated variables are used to control the behaviour of the plant. They include control inputs such as valve strokes, mass flows, rotational speeds, etc, and changeable parameters such as parameters of control loops. Typical manipulated variables are:

Carbon dioxide capture system:

1) Regenerator steam flow, 2) Lean absorbent solution flowrate, 3) cooling water flowrate to the lean cooler, 4) condensate flowrate used to cool the CO₂ rich stream in the CO₂ compression system.

Power production part of the power plant:

1) Fuel mass flow, 2) steam mass flow, 3) feedwater flows, 4) setpoints for pressure levels of steam headers, 5) setpoints for temperature levels of steam headers.

Controlled variables are variables or functions thereof that need to be controlled within certain operational limits. Typical controlled variables are:

Carbon dioxide capture system:

1) CO₂ absorption efficiency, 2) Reboiler heat duty/IP/LP steam flow, 3) Pressure-drop across absorption system, 4) IP steam pressure, 5) Temperature of CO₂ recovered in the overhead of the regenerator, 6) Temperature of the CO₂ rich stream at the entrance of different compression stages.

Power production part of the power plant:

1) Power output, 2) steam pressure and temperature at various locations such as steam headers, 3) steam extraction flows.

Disturbance variables are variables that act as uncontrollable inputs to the plant. Typical disturbance variables are:

Carbon dioxide capture system:

1) CO₂ concentration in the flue gas, 2) Temperature of the flue gas at the entrance of the Carbon dioxide capture system.

Power production part of the power plant:

1) Ambient conditions, 2) fuel quality, 3) variations of component characteristics due to aging such as variations of heat transfer coefficients, 4) unplanned load changes resulting from grid disturbances such as frequency variation, load rejection etc.

A particular embodiment of the plant-wide control system would be implemented by using numerous advanced control schemes, based on Proportional-Integral-Derivative (PID) controllers, such as cascaded control or ratio control etc.

Another embodiment of the plant-wide control system, which might be combined with the embodiment of the previous paragraph, is to use process models along with steady state or dynamic optimization to compute optimal operating parameters for the process.

The optimization procedure may be based on the minimization of an objective function of manipulated variables, controlled variables, and, optionally, estimates of disturbance variables and/or other unknown parameters subject to the plant dynamics expressed by the models described above. The objective function typically penalizes deviations from a fixed operation condition and/or a predefined trajectory and/or time to reach a certain plant condition from a given initial condition and/or fuel consumption, CO₂ production etc.

The optimization procedure may either be carried out off-line or on-line. It may also include features that allow for the estimation of unknown parameters that may for example be used for the stabilization of plant dynamics in order to achieve the optimization objective, e.g. minimize the objective function.

The optimization procedure may be applied to either the carbon dioxide capture system or any other part of the power plant, such as the boiler and/or steam cycle, separately, sequentially or jointly. In particular it may also consist of a differential game between the carbon dioxide capture system and the other part of the plant and/or it may be based on Pontryagin's Minimum Principle.

A special embodiment of the optimization procedure is based on model predictive control, which minimizes an objective function based on predicted plant outputs over a certain time horizon into the future.

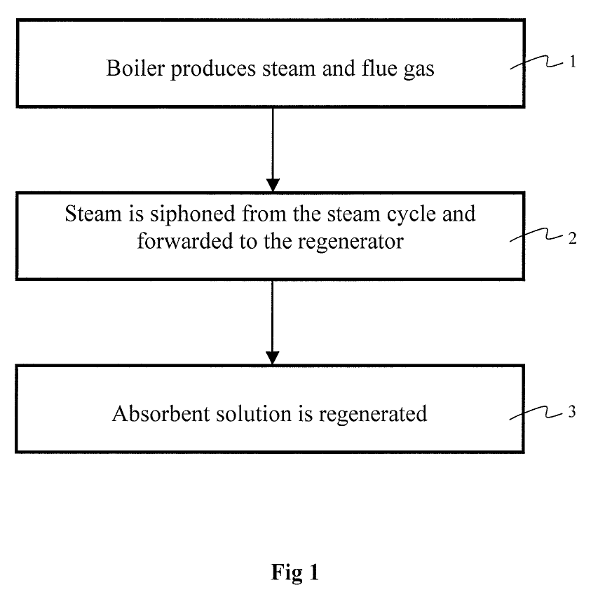

A currently preferred method of controlling a power plant in accordance with the present invention will now be discussed with reference to FIG. 1.

In step 1, a power plant boiler combusts organic fuel to boil water and produce steam. The steam is forwarded through piping to a steam cycle comprising steam turbines for power production, generation of electricity, and the flue gas from the combustion of the organic fuel is forwarded through piping to a gas cleaning system, in which gas cleaning system particles, sulphur and nitrogen containing pollutants etc. are removed from the flue gas, after which the cleaned flue gas is forwarded to the carbon dioxide capture system where carbon dioxide is captured from the flue gas by the absorbent solution.

In step 2, a mixture of intermediate pressure (IP) steam and low pressure (LP) steam is siphoned off from the steam cycle and forwarded to the regenerator of the carbon dioxide capture system. The amount of steam siphoned off is automatically controlled by at least one automatic controller.

In step 3, the hot steam forwarded from the steam cycle exchanges heat with carbon dioxide rich absorbent solution, which solution has captured carbon dioxide from the flue gas, in a reboiler comprised in the regenerator by means of a heat exchanger, whereby the steam is not in direct contact with the absorbent solution. In the regenerator, the carbon dioxide rich absorbent solution is made to boil, giving of a relatively pure carbon dioxide gas stream which is forwarded to a compressor for compression and subsequent storage. At least a substantial part of the carbon dioxide captured by the absorbent solution is thus removed from the absorbent solution, resulting in an unsaturated or lean absorbent solution which is returned to the carbon dioxide removing system for capturing more carbon dioxide from flue gas passing through.

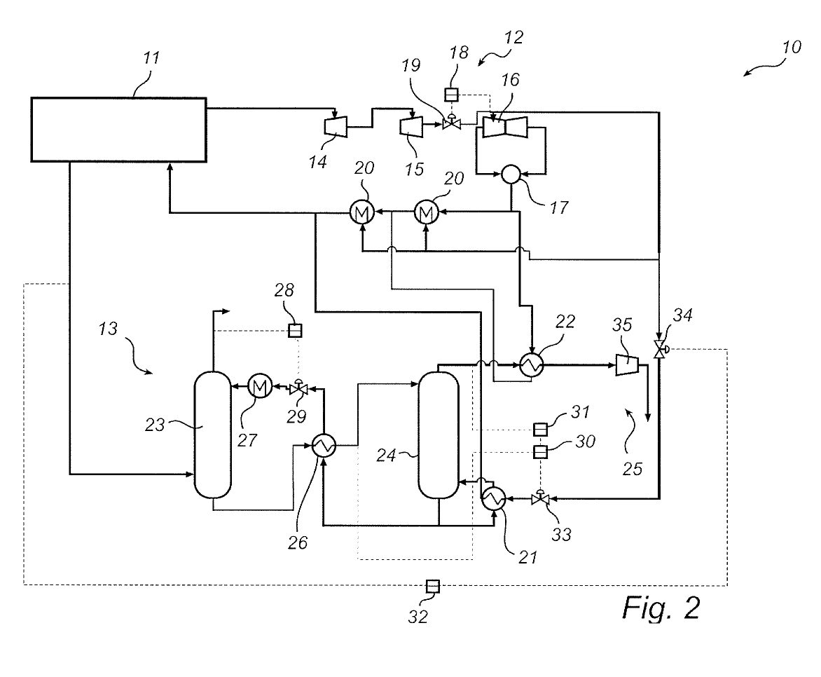

Currently preferred embodiments of a power plant 10 in accordance with the present invention will now be discussed with reference to FIG. 2.

The power plant 10 comprises a boiler 11, a steam cycle 12 and a carbon dioxide capture system 13.

The steam cycle 12 comprises a high pressure turbine 14, an intermediate pressure turbine 15 and a low pressure turbine 16, as well as a condenser 17. Steam from the boiler will pass through the turbines 14, 15 and 16 in sequence during expansion and cooling, after which steam having passed the low pressure turbine 16 will be condensed in the condenser 17 at low pressure. The cold condensate from the condenser 17 may then be forwarded as boiler feedwater towards the boiler 11 to be reused for steam production. Before reaching the boiler the boiler feedwater will be heated by the two boiler feedwater heaters 20 to reduce the heating load of the boiler 11, after which the feedwater re-enters the boiler 11 to complete the steam cycle 12. Some of the condensate from the condenser 17 is however instead used as cooling medium in the CO₂ compression heat exchanger 22 and is thereby heated before being returned to the steam cycle as boiler feedwater, reducing the heating load of the boiler feedwater heaters 20.

In accordance with this embodiment of the present invention, some steam is siphoned away from the steam cycle after it has passed the intermediate pressure turbine 15 but before it has entered the low pressure turbine 16. This steam is partly forwarded as heating medium in the regenerator reboiler 21, and partly forwarded as heating medium in the boiler feedwater heaters 20.

Since the backpressure at the IP-LP crossover ensures supply of steam to both the LP turbine and to the reboiler, this pressure is maintained in the face of changing steam flow to the LP feedwater heaters 20. This is achieved through a pressure controller 18 acting on valve 19.

The carbon dioxide capture system comprises an absorber 23 in which flue gas from the boiler 11 may contact absorbent solution, whereby carbon dioxide is captured from the flue gas by the absorbent solution; a regenerator 24 in which carbon dioxide rich absorbent solution from the absorber 23 may be regenerated through heating by means of the reboiler 21 to give a carbon dioxide lean absorbent solution that may be returned to the absorber 23 as well as a carbon dioxide rich gas stream that may leave the regenerator 24; and a carbon dioxide compression arrangement 25.

The absorber 23 is arranged to admit flue gas from the boiler 11 and carbon dioxide unsaturated or lean absorbent solution from the regenerator and, optionally, from another lean absorbent solution source of fresh lean absorbent solution (not shown). The absorbent solution may be recirculated in the absorber 23. The lean solution from the regenerator 24 may be cooled by heat exchangers 26 and/or 27 before entering the absorber 23. In heat exchanger 26, the lean solution may be cooled by the rich solution leaving the absorber 23 and heading to the regenerator 24. In heat exchanger 27, the lean solution may be additionally cooled by a regular cooling medium such as cold water. Apart from emitting rich absorbent solution, the absorber 23 is also arranged to emit carbon dioxide lean flue gas, i.e. the flue gas after being contacted with the absorbent solution. This lean flue gas exits the power plant 10 and may e.g. be emitted to the atmosphere.

A feedback PID controller 28 would be used to control the amount of CO₂ capture in the absorber 23 even if the amount of flue gas entering the absorber 23 changes. This controller 28 would try to maintain the ratio of lean absorbent solution and flue gas entering the absorber 23 to a set value, typically the design value, by acting on a valve of the lean solution stream e.g. between the heat exchangers 26 and 27, based on e.g. the carbon dioxide content of the flue gas leaving the absorber 23.

The regenerator 24 is arranged to admit carbon dioxide rich absorbent solution from the absorber 23 after having passed through the heat exchanger 26, and to emit carbon dioxide lean absorbent solution to the absorber 23 via the heat exchangers 26 and 27 as well as a carbon dioxide rich gas stream leaving the regenerator 24 and entering the carbon dioxide compression arrangement 25.

The regenerator 24 comprises the reboiler 21 which is a heat exchanger in which steam from the steam cycle, as discussed above, is used to heat the carbon dioxide rich absorbent solution admitted into the regenerator 24 from the absorber 23. During this heating, carbon dioxide captured by the absorbent solution leaves the solution as a carbon dioxide rich gas, or essentially pure carbon dioxide, whereby the absorbent solution is regenerated and may be returned to the absorber 23.

One or several controllers 30, 31 and 32 shown in FIG. 2 may be used to control the amount of steam fed to the reboiler 21 in view of the overall operation of the power plant 10.

The rich absorbent solution stream entering the regenerator may also have different flow and/or different CO₂ composition if e.g. the flue gas load of the carbon dioxide capture system changes. To minimize the energy consumed by the reboiler, the steam flow rate may be controlled by a controller 30 based on the rich absorbent solution stream entering the regenerator. This will be a feedforward controller 30.

Alternatively, or additionally, to controller 30, a controller 32 could be used, which controller 32 uses a measurement of the flue gas stream to the absorber 23 for feedforward control of the steam flow to the reboiler 21.

To provide finely tuned control for the regeneration of solution in the regenerator, an additional controller 31, a feedback controller 31, may further regulate the steam flow to the reboiler based on a tray temperature in the regenerator. The temperature to be measured could be the temperature of the CO₂ rich gas stream leaving the regenerator or at any intermediate stage in the regenerator.

The controllers 30, 31 and 32 may act on e.g. a valve 33 of the steam stream just before it enters reboiler 21 and/or on a throttling valve 34 after the IP-LP crossover. In this specific embodiment, controllers 30 and 31 act on valve 33, and controller 32 acts on valve 34.

The carbon dioxide compression system 25 comprises the heat exchanger 22, discussed above, and the compressor 35. The compressor 35 may compress the carbon dioxide rich gas stream from the regenerator to facilitate storage of the carbon dioxide, which may be essentially pure. The carbon dioxide may even be compressed to liquid form. The compressed carbon dioxide leaves the power plant 10 and may e.g. be sold or more permanently stored to avoid emission to the atmosphere.

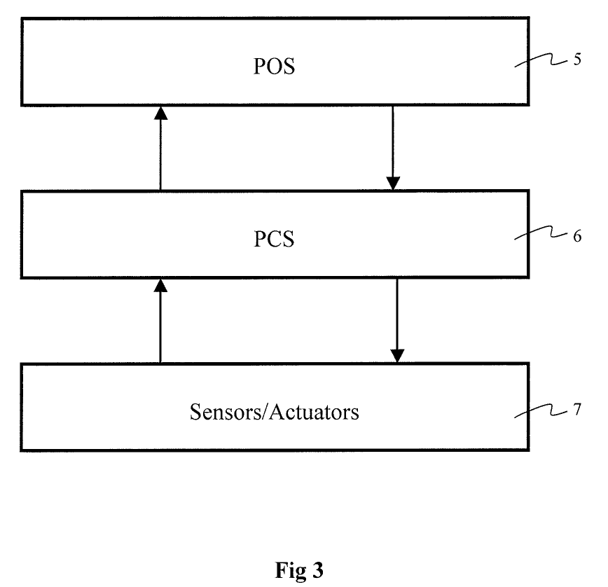

With reference to FIG. 3, a currently preferred optimization system in accordance with the present invention will now be discussed, the optimization system being an implementation of the plant-wide control strategy of the invention.

FIG. 3 shows schematically the working of a plant-wide optimization system (POS) 5 in accordance with the invention. The PCS 6 gets relevant data from different sensors 7 within the power plant. Based on this data, the output of the various manipulated variables is calculated using the process model and some optimization procedure described above and relayed back to the actuators.

The PCS 6 may e.g. be a data acquisition system comprising a distributed control system (DCS) and a programmable logical controller (PLC).

The arrows to the left in FIG. 4 symbolizes the flow of process data upwards in the optimization system, and the arrows to the right symbolizes the output of the optimization system.

### EXAMPLE 1

A particular example of a plant-wide control system using PID controllers is described below:
1. A simple feedback PID controller would be used to control the amount of CO₂ capture in the face of changing load. This controller would try to maintain the ratio of lean solution and flue gas entering the absorber to a set value, typically, the design value.
2. Based on the controller described in 1, the rich solution stream entering the regenerator will also have different flow and/or different CO₂ composition. To minimize the energy consumed by the reboiler, the steam flow rate will be changed based on the amount of flue gas entering the CO₂ capture system. This will be a feedforward controller.
3. To provide finely tuned control for the solution regenerated in the regenerator, an additional controller, a feedback controller, will further regulate the steam flow to the reboiler based on a tray temperature in the regenerator. The temperature to be controlled could be the temperature of the CO₂ rich gas stream leaving the regenerator or at any intermediate stage in the regenerator, to be determined by pilot plant experiments for a given design.
4. These two controllers together form an advanced control scheme that could be called “feedforward with feedback trim”. The feedforward controller provides the major change in steam flow in order to account for the change in the rich absorbent flow, while the feedback controller provides the fine-tuning.
5. Since the backpressure at the IP-LP crossover ensures supply of steam to both the LP turbine and to the reboiler, this pressure is maintained in the face of changing steam flow to the LP feedwater heaters. This is achieved through a simple pressure controller.
6. Another set of PID feedback controllers will be used to control the flow of the stream from the condenser that is used to cool the CO₂ rich stream in the compression section.
7. In addition, this example will also have other controllers to maintain temperature of the lean solution flowing to the absorber etc.
8. The calculations for all the feedforward loops, the design ratios etc. will be determined based on each power plant process. These relationships, either fundamental or empirical may be considered to constitute the “process model”.

### EXAMPLE 2

An alternative scheme would be to, instead of, or as a complement to, steps 2-4 of example 1 use the temperature in the reboiler to manipulate the heat duty. This would be a slower loop but would give good response for feed flow changes.

### EXAMPLE 3

Another alternative scheme would be to, instead of, or as a complement to, steps 2-4 of examples 1 or 2 use the flue gas flow signal as a feedforward for a feedforward controller that manipulates the steam flow through the throttling valve after the IP-LP crossover. Fine tuning CO₂ removal from rich absorbent may then be obtained by further manipulating the steam flow to the reboiler based on a tray temperature in the regenerator.

### EXAMPLE 4

A typical example of the plant-wide optimization system (POS) implemented as a model predictive control system is presented below. In this particular example, the POS is operated with the following objectives:
Maintain CO₂ absorption at a prescribed level while
minimizing the parasitic load of the carbon dioxide capture system to the power production due to the siphoning off of steam from the steam cycle.
Minimizing disturbance to boiler operation due to heat integration with the carbon dioxide capture system.
1. Consider a scenario wherein the power plant is operating at “steady state” conditions.
2. The plant load may change due to some unforeseen circumstance. As the flue gas flow rate/plant load decreases, the CO₂ concentration in the flue gas and flue gas temperature also change. These signals are sent to the PCS, which takes action based on the size of the change.
3. The way the control system works in this case is as follows:
   a. As the plant load decreases, the PCS calculates the optimal reduced amount of lean absorbent solution flow to the absorber in order to maintain the CO₂ absorption efficiency. This optimal flowrate is passed as a setpoint to the lean absorbent flow controller.
   b. At the same time, the steam flow to the regenerator is also reduced in order to account for the lesser amount of CO₂ captured. An optimal setpoint for the steam flow to the regenerator is calculated and provided to the regulatory controller.
   c. A decreased condensate flow from the regenerator will increase the heating demand for the boiler feedwater (BFW) heaters. The PCS calculates the flow setpoint of IP/LP steam for the BFW heaters in order to compensate for the decreased condensate flow.
   d. Similarly, the temperature of condensate flow from the condenser will also decrease as it exchanges heat with a smaller CO₂ rich stream in the Compression system. This will also increase the heating requirement of the BFW heaters mentioned in (c) above. To avoid this, the PCS would decrease the flow of condensate from condenser to the compression system thus ensuring no or lesser increase in heating requirement of the BFW heaters.
   e. Finally, the PCS will also calculate a new setpoint for the cooling water flow rate to the heat exchanger for cooling of the lean absorbent in the CO₂ capture system.
   f. Since one of the objectives of the PCS is to minimize parasitic load, a variable representing the entire parasitic load due to the CO₂ capture system will be used and the optimizer will try and minimize this value by changing the manipulated variables.
   g. As has been noted earlier, all the calculations will be done either using steady state models and optimizer or using dynamic models and optimizer or combining both steady-state and dynamic optimization
4. As can be seen above, in the model predictive control manifestation, the POS manipulates the setpoints of the regulatory PID controllers rather than changing the actual values.
   The independent (manipulated or disturbance) variables and dependent (controlled) variables in the example would be as follows:

| Independents | Dependents |
|---|---|
| Steam flow to reboiler | CO₂ absorption efficiency |
| Lean absorbent flow to absorber | Overall parasitic heat load (reboiler |
| | duty+ BFW heating load etc.) |
| IP/LP steam flow to BFW heaters | IP/LP Module exhaust pressure |
| Condensate flow to cool CO₂ rich | CO₂ temperature in the overhead |
| stream in CO₂ compression system | of the regenerator |
| Cooling water flow to lean cooler | Rich absorbent flowrate |
| Flue gas flowrate/Plant load | Steam pressure and temperature |
| | (steam quality) |
| CO₂ composition in flue gas | CO₂ rich stream temperature at each |
| | compression stage |
| Flue gas temperature | Pressure-drop across absorber |
| | IP/LP steam pressure |

1. A method of controlling a power plant, which power plant comprises:
a power plant boiler being adapted for combusting an organic fuel and for generating steam and a process gas comprising carbon dioxide;
a steam system being adapted for utilizing at least a portion of the energy content of at least a portion of the steam generated by said power plant boiler; and
a carbon dioxide capture system being adapted to remove at least a portion of the carbon dioxide from at least a portion of said process gas by contacting a carbon dioxide absorbent solution with the process gas such that carbon dioxide from said process gas generated in the power plant boiler is captured by the carbon dioxide absorbent making the carbon dioxide absorbent rich in carbon dioxide,
the method comprising:
forwarding a regenerator portion of the steam produced by the power plant boiler to a regenerator of the carbon dioxide capture system;
at least partly regenerating the absorbent solution in said regenerator through heating of said carbon dioxide absorbent solution when it is rich in carbon dioxide, by means of the forwarded steam to make the absorbent solution carbon dioxide lean; and
automatically controlling the operation of the carbon capture system by means of at least one automatic controller.

2. A method according to claim 1, wherein the steam is forwarded from the power plant boiler to the regenerator of the carbon dioxide capture system via said steam system.

3. The method of claim 1, wherein the operation of the carbon dioxide capture system is controlled automatically by a plurality of automatic controllers.

4. The method of claim 3, wherein the plurality of controllers are controlled by an automatic master controller.

5. The method of claim 1, wherein the at least one controller is part of an optimization system arranged to optimize the overall operation of the power plant.

6. The method of claim 5, wherein the optimization is performed by continuously calculating and assigning setpoints to the at least one controller.

7. The method of claim 5, wherein the operation of the power plant is optimized using steady state optimization.

8. The method of claim 5, wherein the operation of the power plant is optimized using dynamic optimization.

9. The method of claim 5, wherein the optimization is based on the minimization of an objective function of at least one variable, selected from the group consisting of manipulated variables, controlled variables and disturbance variables, related to the operation of the power plant.

10. The method of claim 5, wherein the optimization is based on differential game and/or on Pontryagin's Minimum Principle.

11. The method of claim 5, wherein the operation of the power plant including the carbon dioxide capture system is optimized with regard to maximum power output of the power plant, while maintaining carbon dioxide capture at a prescribed level.

12. The method of claim 5, wherein the optimization of the operation of the power plant includes a tradeoff between the power output of the power plant and the carbon dioxide capture level.

13. The method of claim 1, wherein the at least one controller controls the regenerator portion amount of the steam forwarded to the regenerator.

14. The method of claim 13, wherein the at least one controller controls the regenerator portion amount of the steam forwarded to the regenerator at least partially based on a measured value of at least one variable related to properties of a stream of the absorbent solution entering the regenerator, said measured value related to properties of a stream of the absorbent solution entering the regenerator being automatically received by the controller.

15. The method of claim 13, wherein the at least one controller controls the regenerator portion amount of the steam forwarded to the regenerator at least partially based on a measured value of at least one variable related to properties of a stream of the process gas from the power plant boiler, said measured value related to properties of a stream of the process gas from the power plant boiler being automatically received by the controller.

16. The method of claim 13, wherein the at least one controller controls the regenerator portion amount of the steam forwarded to the regenerator at least partially based on a measured value of at least one variable related to properties of a stream of a carbon dioxide rich gas inside or leaving the regenerator, said measured value of at least one variable related to properties of a stream of a carbon dioxide rich gas inside or leaving the regenerator being automatically received by the controller.

17. The method of claim 13, wherein a plurality of automatic controllers cooperate to control the regenerator portion amount of the steam forwarded to the regenerator.

18. The method of claim 1, wherein at least a portion of the regenerator portion of the steam forwarded to the regenerator is returned to the power plant boiler as feedwater.

19. The method of claim 1, wherein the carbon dioxide capture system comprises an absorber arrangement in which the process gas is contacted with an absorbent solution amount provided to the absorber arrangement, whereby carbon dioxide is captured from the process gas by the absorbent solution.

20. The method of claim 19, wherein the at least one controller controls the absorbent solution amount provided to the absorber arrangement at least partially based on a measured value of at least one variable related to properties of a stream of the process gas, which stream is leaving the absorber arrangement, said measured value of at least one variable related to properties of a stream of the process gas being automatically received by the controller.

21. The method of claim 20, wherein the at least one variable is one or several of flow rate, temperature, pressure and carbon dioxide concentration.

22. The method of claim 1, wherein at least a portion of the regenerator portion amount of steam is siphoned off from a steam stream after said steam stream has passed through at least one steam turbine.

23. The method of claim 1, wherein the regenerator portion of steam forwarded to the regenerator is intermediate pressure steam or low pressure steam, or a mixture of intermediate and low pressure steam.

24. The method of claim 1, wherein at least a portion of the steam produced by the power plant boiler is condensed in a power plant condenser producing a condensate, at least a portion of which condensate being forwarded to a heat exchanger for cooling a carbon dioxide rich gas stream from the regenerator of the carbon dioxide capture system, after which the condensate portion is returned to the boiler as feedwater.

25. The method of claim 24, wherein the condensate portion amount forwarded to the heat exchanger is automatically controlled by the at least one automatic controller.

26. A power plant comprising:
a power plant boiler being adapted for combusting an organic fuel and for generating steam and a process gas comprising carbon dioxide;
a steam system being adapted for utilizing at least a portion of the energy content of at least a portion of the steam generated by said power plant boiler; and
a carbon dioxide capture system being adapted to remove at least a portion of the carbon dioxide from said process gas by contacting a carbon dioxide absorbent solution with the process gas such that carbon dioxide from said process gas generated in the power plant boiler is captured by the carbon dioxide absorbent making the carbon dioxide absorbent rich in carbon dioxide, the carbon dioxide capture system comprising:
an absorption arrangement arranged to facilitate contact between the process gas and an absorbent solution, wherein the absorption arrangement is connected to the power plant such that at least a portion of the process gas produced by the boiler may be forwarded from the power plant to the absorption arrangement;
a regenerator arranged to regenerate the absorbent solution such that absorbent solution, rich in captured carbon dioxide, is at least partly regenerated by removing carbon dioxide from the absorbent solution, wherein the regenerator is connected to the power plant such that at least a regenerator portion of the steam produced by the boiler may be forwarded from the power plant to the regenerator; and
an automatic controller arranged to control the operation of the carbon dioxide capture system.
